(19) United States
(12) Patent Application Publication
(10) Pub. No.: US 2015/0254211 A1
(43) Pub. Date: Sep. 10, 2015

(54) INTERACTIVE DATA MANIPULATION USING EXAMPLES AND NATURAL LANGUAGE

(71) Applicant: Microsoft Technology Licensing, LLC, Redmond, WA (US)

(72) Inventors: Sumit Gulwani, Bellevue, WA (US); Edward C. Hart, JR., Redmond, WA (US); Vu Minh Le, Davis, CA (US); Henrique S. Malvar, Redmond, WA (US); Mark Marron, Bellevue, WA (US); James D. McCaffrey, Sammamish, WA (US); Gustavo Araujo Soares, Campina Grande (BR); Benjamin G. Zorn, Woodinville, WA (US)

(21) Appl. No.: 14/622,140

(22) Filed: Feb. 13, 2015

Related U.S. Application Data
(60) Provisional application No. 61/950,059, filed on Mar. 8, 2014.

(51) Int. Cl. G06F 17/21; G06F 3/0484; G06F 17/24; G06F 17/27; G06F 17/28

(52) U.S. Cl. CPC G06F 17/211; G06F 17/2705; G06F 17/28; G06F 17/24; G06F 3/0484

(57) ABSTRACT

Various technologies described herein pertain to controlling programming for manipulating an input document based on example(s) and/or natural language input(s). A data manipulation system includes an interface component configured to receive an input document, which is semi-structured or unstructured. The data manipulation system further includes an extraction component configured to synthesize, based on a first input, a first program for parsing data of the input document. The extraction component is configured to execute the first program on the input document to form structured data. The data manipulation system also includes an operation component configured to synthesize, based on a second input, a second program for performing an operation on the structured data. The operation component is configured to execute the second program on the structured data to generate a result of the operation, which is output by the data manipulation system.

### CROSS-REFERENCE TO RELATED APPLICATION

This application claims priority to U.S. Provisional Patent Application No. 61/950,059, filed on Mar. 8, 2014, and entitled “INTERACTIVE DATA MANIPULATION USING EXAMPLES AND NATURAL LANGUAGE”, the entirety of which is incorporated herein by reference.

### BACKGROUND

The information technology revolution over the past few decades has resulted in various advances. Examples of such advances include the digitization of massive amounts of data and widespread access to computational devices. However, there is a wide gap between access to rich digital information and the ability to manipulate and analyze such data.

Information is available in various document types such as text files, log files, spreadsheets, and webpages. These documents allow their creators flexibility in storing and organizing hierarchical data by combining presentation and formatting details with the underlying data model. However, such flexibility can cause difficulty when attempting to extract, modify, or query the underlying data.

### SUMMARY

Described herein are various technologies that pertain to controlling programming for data manipulation executed on an input document based on example(s) and/or natural language input(s). A computing system includes at least one processor and memory, and the memory includes a data manipulation system executable by the at least one processor. The data manipulation system can include an interface component configured to receive an input document. The input document can be a semi-structured document or an unstructured document. Moreover, the data manipulation system can include an extraction component configured to synthesize a first program for parsing data of the input document. The first program can be synthesized by the extraction component based on a first input. The first input can include a first example (or first examples) and/or a first natural language input (or first natural language inputs). Further, the extraction component can be configured to execute the first program on the input document to form structured data. The data manipulation system can further include an operation component configured to synthesize a second program for performing an operation on the structured data. The second program can be synthesized by the operation component based on a second input. The second input can include a second example (or second examples) and/or a second natural language input (or second natural language inputs). The operation component can also be configured to execute the second program on the structured data to generate a result of the operation. The result of the operation can be output by the data manipulation system.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 illustrates a functional block diagram of an exemplary system that controls programming for data manipulation executed on an input document based on example(s) and/or natural language input(s).

FIG. 2 illustrates a functional block diagram of another exemplary system that controls programming for data manipulation tasks performed on an input document based on example(s) and/or natural language input(s).

FIG. 3 illustrates a functional block diagram of an exemplary system that employs server-side control of programming for data manipulation tasks executed on an input document.

FIGS. 4-8 illustrate a uniform user interface that can be rendered upon a display device of a computing device during operation of a data manipulation system in accordance with a first exemplary scenario.

FIGS. 9-12 illustrate the uniform user interface that can be rendered upon the display device of the computing device during operation of the data manipulation system in accordance with a second exemplary scenario.

FIG. 13 is a flow diagram that illustrates an exemplary methodology of controlling programming for data manipulation executed on data of an input document.

FIG. 14 is a flow diagram that illustrates another exemplary methodology of controlling programming for data manipulation executed on data of an input document.

FIG. 15 illustrates an exemplary computing device.

FIG. 16 illustrates an exemplary computing system.

### DETAILED DESCRIPTION

Various technologies pertaining to controlling programming for manipulating data of an input document based on example(s) and/or natural language input(s), where the input document is a semi-structured document or an unstructured document, are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

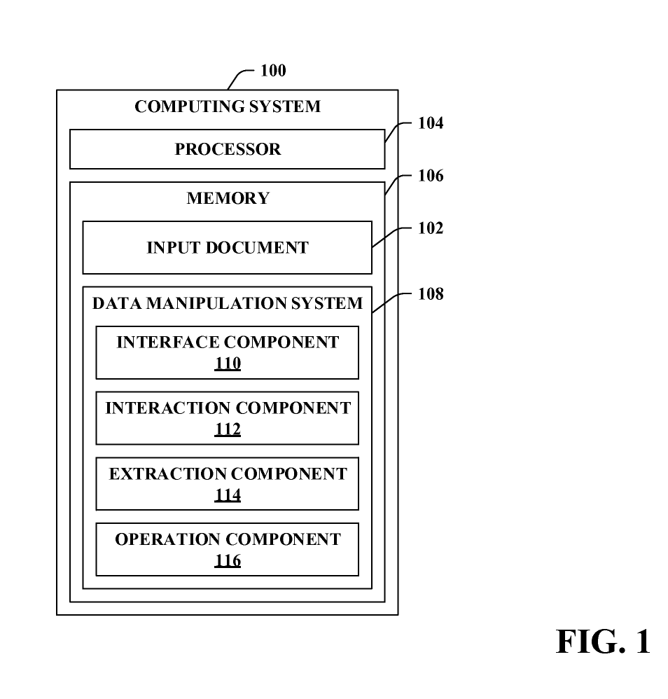

Referring now to the drawings, FIG. 1 illustrates a computing system 100 that controls programming for data manipulation executed on an input document 102 based on example(s) and/or natural language input(s). The computing system 100 includes at least one processor 104 and memory 106. The processor 104 is configured to execute instructions loaded into the memory 106 (e.g., one or more systems loaded into the memory 106, one or more components loaded into the memory 106, etc.). As described in greater detail herein, the memory 106 includes a data manipulation system 108 executable by the processor 104. The data manipulation system 108 is configured to control programming for manipulating data of the input document 102 based on example(s) and/or natural language input(s). The memory 106 can further include the input document 102.

Pursuant to various examples, the computing system 100 can be a computing device. Substantially any type of computing device is intended to fall within the scope of the hereto appended claims. Examples of such computing device include a desktop computing device, a mobile computing device (e.g., a mobile telephone such as a smartphone, a laptop computing device, a netbook computing device, a tablet computing device, a wearable computing device, a handheld computing device, a portable gaming device, a personal digital assistant, an automotive computer, etc.), a gaming console, a set-top box, a television, an embedded computing device, or the like.

According to other examples, the computing system 100 can be or include one or more server computing devices. For instance, the computing system 100 can be or include one or more datacenters, where a datacenter includes a plurality of server computing devices. One or more datacenters can alternatively include the computing system 100. Further, the computing system 100 can be a distributed computing system.

The data manipulation system 108 allows the data of the input document 102 to be manipulated using a combination of examples and natural language inputs. The data manipulation system 108 can be employed to manipulate data of various input document types that are semi-structured or unstructured. Exemplary input document types include text files, log files, word processor documents, semi-structured spreadsheets, webpages, fixed-layout documents (e.g., Portable Document Format (PDF) documents), and so forth. The input document 102 can include a nested structure, a non-uniform structure, nested records, sub-headers or the like.

The data manipulation system 108 enables interactive manipulation and analysis of semi-structured or unstructured data of the input document 102 using a combination of examples and natural language inputs. The data manipulation system 108 combines programming by example (PBE) and programming by natural language (PBNL) using a uniform user interface to provide data manipulation capabilities. The data manipulation capabilities can be supported by the data manipulation system 108 utilizing PBE and/or PBNL techniques without a user programming macros, scripts, or the like. In contrast to the data manipulation system techniques set forth herein, some conventional techniques for data manipulation provide various menu options; however, a user may have difficulty locating an appropriate menu option to perform a desired task. Further, other more sophisticated tasks traditionally may be carried out by programming a macro, script, or the like. Yet, at least some users may lack programming expertise to create such macros, scripts, or the like.

The data manipulation system 108 leads to improved user efficiency for performing data manipulation tasks on the data of the input document 102 as compared to conventional techniques. For instance, a user need not learn how to create a program to perform a data manipulation task. Moreover, a user need not take the time to generate the program for the data manipulation task. Further, user interaction performance can be improved in comparison to conventional techniques. By way of illustration, the user need not traverse through a menu-based system to select tasks to perform on the data of the input document 102; instead, the user can provide example(s) and/or natural language input(s) via a uniform user interface, and program(s) can be synthesized and executed based upon such inputs.

The data manipulation system 108 can include an interface component 110 configured to receive the input document 102. For instance, the interface component 110 can import the input document 102 into the data manipulation system 108. Moreover, for some documents types (e.g., text files, log files, word processor documents, semi-structured spreadsheets), the interface component 110 can output a modified version of the input document 102. According to an illustration, the input document 102 can be modified by the data manipulation system 108, and the interface component 110 can output the modified version of the input document 102.

The data manipulation system 108 further includes an interaction component 112 that can be configured to generate a uniform user interface. The uniform user interface can be uniform across various input document formats. Moreover, the interaction component 112 can be configured to receive various inputs. The inputs that the interaction component 112 can receive can include example(s) and/or natural language input(s). It is contemplated that the inputs received by the interaction component 112 can be received from a user of the computing system 100 (e.g., the user provides the inputs to the computing system 100 via input device(s) of the computing system 100, the computing system 100 can include or be coupled with the input device(s)). According to another example, the inputs received by the interaction component 112 can be received from a client computing device, where a user provides the inputs to the client computing device (e.g., via an input device(s) of the client computing device).

Upon being imported via the interface component 110, various data manipulation tasks can be performed upon the input document 102. The data manipulation tasks can be programmed using the inputs received by the interaction component 112. For instance, the data manipulation tasks can be programmed using examples, natural language inputs, or a combination of examples and natural language inputs. Further, the data manipulation system 108 can synthesize various programs, which can interoperate with each other. The program synthesis algorithms implemented by the data manipulation system 108 can employ various backend services, such as, programming by example (PBE) services, programming by natural language (PBNL) services, semantic lookup, and so forth.

The data manipulation system 108 includes an extraction component 114 configured to synthesize a first program for parsing data of the input document 102. The first program can be synthesized by the extraction component 114 based on a first input. For instance, the interaction component 112 can receive the first input for parsing the data of the input document 102. The first input can include first example(s) and/or first natural language input(s). The extraction component 114 can further be configured to execute the first program on the input document 102 to form structured data. The extraction component 114 can synthesize the first program using PBE and/or PBNL; thus, the extraction component 114 can form the structured data from the data of the input document 102 using PBE and/or PBNL. The structured data formed by the extraction component 114 can have a tabular structure or a tree-shaped structure, for example.

The data manipulation system 108 further includes an operation component 116 configured to synthesize a second program for performing an operation on the structured data. The second program can be synthesized by the operation component 116 based on a second input. The interaction component 112, for instance, can receive the second input for performing the operation on the structured data. The second input can include second example(s) and/or second natural language input(s). The operation component 116 can further be configured to execute the second program on the structured data to generate a result of the operation. The result of the operation can be output by the data manipulation system 108. The operation component 116 can be configured to synthesize the second program using PBE and/or PBNL; thus, the operation component 116 can generate the result of the operation on the structured data using PBE and/or PBNL.

A workflow supported by the data manipulation system 108 can be to first parse unstructured or semi-structured data of the input document 102 to impose structure, and then perform an operation on structured data that is formed, such as transforming or querying the structured data. Thus, the extraction component 114 can create the structured data over the underlying unstructured or semi-structured data of the input document 102. Thereafter, the operation component 116 can perform the operation on the structured data to generate the result of the operation. It is contemplated that substantially any number of additional operations can similarly be performed by the operation component 116 on the structured data.

Thus, the data manipulation system 108 can program the data manipulation tasks using a sequence of steps. For instance, the extraction component 114 can form the structured data from the input document 102. Thereafter, the operation component 116 can generate a result of an operation on the structured data. Each of the tasks in the sequence can use examples as input, natural language as input, a combination of examples and natural language as input, or either examples or natural language as input.

Pursuant to an example, the data manipulation system 108 can store the programs synthesized by the extraction component 114 and the operation component 116 (e.g., obtained by the sequence of interactions in the form of examples and/or natural language over the input document 102) as a synthesized script. The synthesized script, for instance, can be retained in the memory 106, a data store of the computing system 100, or the like. Further, the synthesized script can be executed on a differing input document with similar format as compared to the input document 102 (e.g., the input document 102 and the differing input document can both be webpages, etc.). Accordingly, a similar output (e.g., similar types of results) can be generated by the data manipulation system 108 for the differing input document. For instance, further input in the form of examples and/or natural language need not be provided to the data manipulation system 108 when executing the synthesized script; yet, it is also contemplated that the synthesized script can be modified by additional input when executed on the differing input document.

According to a further example, the extraction component 114 can form the structured data using inputted examples received by the interaction component 112. Following this example, the extraction component 114 can be employed to highlight relevant data in the input document 102 to impose structure on top of the semi-structured or unstructured input document 102 using the examples received via the interaction component 112. The extraction component 114 can create a tabular or tree-shaped structure over the underlying semi-structured or unstructured input document 102 using PBE services. The semi-structured or unstructured input document 102, for example, can include a nested structure, a non-uniform structure, or the like.

According to another example, the extraction component 114 can form the structured data from a semi-structured spreadsheet (e.g., the input document 102) with nested records, sub-headers, or the like. Thus, the extraction component 114 can employ PBE services to create a tabular structure over such semi-structured spreadsheet. Further, relational data can be extracted from the underlying semi-structured spreadsheet.

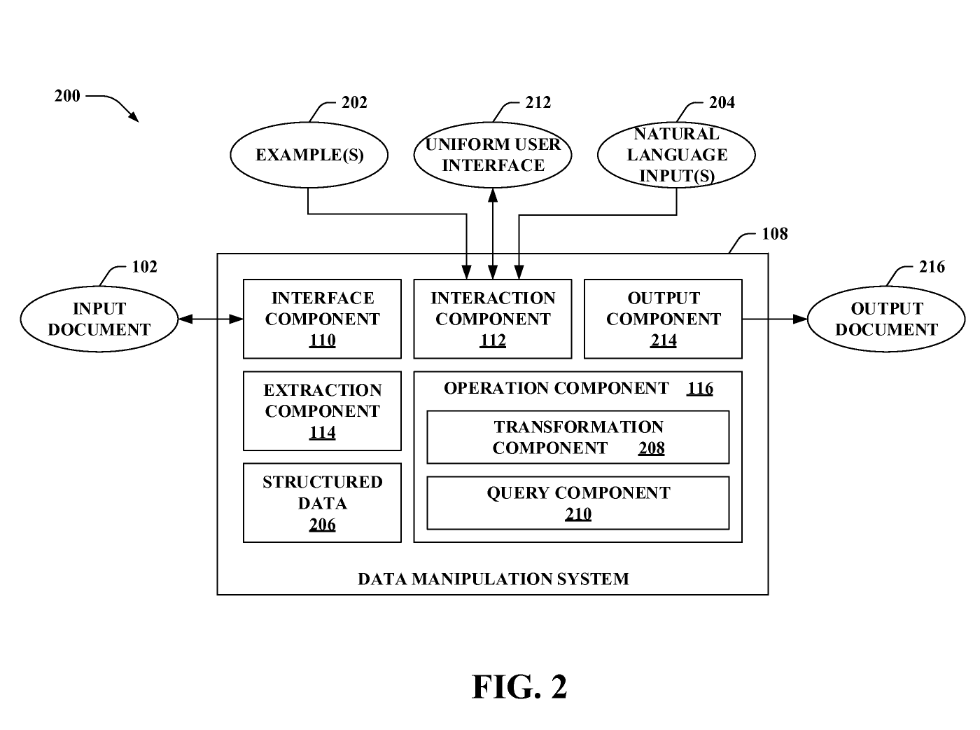

With reference to FIG. 2, illustrated is a system 200 that controls programming for data manipulation tasks performed on the input document 102 based on example(s) 202 and/or natural language input(s) 204. The system 200 includes the data manipulation system 108, which further includes the interface component 110, the interaction component 112, the extraction component 114, and the operation component 116. Again, the interface component 110 can receive the input document 102.

Moreover, the interaction component 112 can receive example(s) 202 and/or natural language input(s) 204. The example(s) 202 can include one or more positive examples and/or one or more negative examples. Such positive examples and/or negative examples can be used as input for PBE services provided by the data manipulation system 108 (e.g., provided by the extraction component 114 and/or the operation component 116). Moreover, the natural language input(s) 204 received by the interaction component 112 can be used as input for PBNL services provided by the data manipulation system 108 (e.g., provided by the extraction component 114 and/or the operation component 116).

As noted above, the extraction component 114 can be configured to synthesize a first program for parsing data of the input document 102 based on a first input received by the interaction component 112. Moreover, the extraction component 114 can be configured to execute the first program on the input document 102 to form structured data 206. The structured data 206 formed by the extraction component 114 can provide a data model upon which various exemplary operations, including map, transform, filter, reduce, and so forth, can be performed.

Further, the operation component 116 can be configured to synthesize a second program for performing an operation on the structured data 206. The second program can be synthesized by the operation component 116 based on a second input received by the interaction component 112. The operation component 116 can execute the second program on the structured data 206 to generate a result of the operation.

The operation component 116 can further include a transformation component 208 and/or a query component 210. Thus, depending upon the type of operation being performed on the data of the input document 102 (e.g., on the structured data 206), the second program can be synthesized and executed by the transformation component 208 or the query component 210.

The extraction component 114 can cause the structured data 206 to be highlighted over the data of the input document 102. The transformation component 208 can perform a content transformation on the highlighted data in the input document 102 using the input received via the interaction component 112. For instance, the transformation component 208 can perform a string transformation using PBE services based upon the example(s) 202 (e.g., an example of a transformation can be received by the interaction component 112).

Thus, the second program can be a transformation program for transforming text strings having a selection criterion, where the structured data 206 includes the text strings. Accordingly, the operation performed by the transformation component 208 can be a transformation of the text strings in the structured data 206 having the selection criterion. The transformation component 208 can be configured to synthesize the transformation program based on the second input. The second input can provide a modified text string corresponding to a text string in the structured data 206. The modified text string can be indicative of a transformation performed on the text string. Moreover, the transformation program can be configured to transform the text strings having the selection criterion in the structured data 206 to corresponding modified text strings. The transformation component 208 can also be configured to evaluate the structured data to identify the text strings having the selection criterion. Further, the transformation component 208 can be configured to transform the text strings having the selection criterion to the corresponding modified text strings using the transformation program.

According to another example, the second program executed on the structured data 206 can be a query program; the query component 210 can synthesize and execute such second program. The query component 210, for example, can query and/or manipulate the structured data 206 utilizing PBNL services based upon the natural language input(s) 204 received by the interaction component 112. The operation performed by the operation component 116 can include execution of a natural language query over the structured data 206. The query component 210 can be configured to synthesize the query program based on the second input and the structured data 206, where the second input includes a natural language query (e.g., the natural language input(s) 204). Moreover, the query component 210 can be configured to generate the result using the query program, where the result is responsive to the natural language query. The query component 210 can enable querying the structured data 206 generated by the extraction component 114.

It is further contemplated that a plurality of operations can be performed by the operation component 116. In accordance with an exemplary scenario, a transformation program can be synthesized and executed by the transformation component 208 on the structured data 206. Thereafter, a query program can be synthesized and executed by the query component 210 on the structured data 206 as transformed by the transformation component 208. However, it is to be appreciated that the claimed subject matter is not limited to the aforementioned exemplary scenario, as any order of operations and/or number of operations performed by the operation component 116 are intended to fall within the scope of the hereto appended claims.

The data manipulation system 108 (e.g., the extraction component 114) enables technologies that operate on structured data (e.g., provided by the operation component 116) to be operable on unstructured or semi-structured data of the input document 102 by imposing structure on the input document 102. The structure can be imposed on the unstructured or semi-structured data of the input document 102 by the extraction component 114. Thereafter, the structured data 206 can be transformed by the transformation component 208, queried by the query component 210, or the like.

Moreover, the interaction component 112 can further be configured to support a uniform user interface 212. The uniform user interface 212 can be uniform for a variety of input document types. The uniform user interface 212 can include a region that includes a graphical representation of the data of the input document 102. The uniform user interface 212 can be used to highlight a region(s) over portion(s) of the data of the input document 102. A highlighted region can be rectangular, for instance; however, other shapes are intended to fall within the scope of the hereto appended claims. The uniform user interface 212 can allow for highlighting region(s) on the input document 102 that include data (e.g., text) that is to be extracted irrespective of the type of the input document 102 (e.g., even though underlying PBE technologies for synthesizing programs for parsing data of input documents may be different for different types of input documents). By way of illustration, PBE technology for extraction from web pages may be different from PBE technology for extraction from text or log files; however, for both scenarios, regions of the uniform user interface 212 can be selected and highlighted.

Responsive to receipt of the first input, the interaction component 112 can incorporate a graphical representation of the first input as part of the uniform user interface 212. The graphical representation of the first input can include a highlighted region over a portion of the data of the input document 102, where the extraction component 114 can synthesize the first program based at least on the portion of the data of the input document 102 included in the highlighted region. Thus, for instance, the first input can be an example that causes the interaction component 112 to insert the highlighted region over the portion of the data of the input document 102. Responsive to execution of the first program by the extraction component 114 to form the structured data 206, the interaction component 112 can be configured to incorporate the structured data 206 as part of the uniform user interface 212. The structured data 206 can be incorporated into the region of the uniform user interface 212 that includes the data of the input document 102. Further, the structured data 206 can be incorporated by including highlighted regions over portions of the data of the input document 102. Moreover, responsive to receipt of the second input, the interaction component 112 can be configured to incorporate a graphical representation of the second input as part of the uniform user interface 212. The second input, for instance, may include a query (e.g., natural language query); accordingly, the graphical representation of the second input can be incorporated as part of the uniform user interface 212 by inserting the query as part of the uniform user interface 212 (e.g., in a query field, etc.). According to another illustration, the second input can include an example transformation of a portion of the data of the input document 102; thus, the graphical representation of the second input can depict such example transformation (e.g., by underlining text, striking through text, etc.). The uniform user interface 212 can further be configured to incorporate the result of the operation generated by the operation component 116 (e.g., the result of a transformation, the result of a query, etc.) as part of the uniform user interface 212.

Moreover, multiple options can be presented as part of the uniform user interface 212 during any stage of interaction with the data manipulation system 108. The PBE and/or PBNL technologies can cause multiple options to be presented, of which one of the options can be selected (e.g., based on an input). The multiple options can be presented since a user's intent in the form of examples and natural language can be ambiguous or under-specified.

The data manipulation system 108 can further include an output component 214 configured to generate an output document 216. The output document 216 can include the structured data 206. It is contemplated that the structured data 206 formed from the input document 102 can be transformed by the transformation component 208; further, the output document 216 created by the output component 214 can include the structured data 206 as transformed. The output document 216, for instance, can be a structured spreadsheet, a structured data file, or the like. Further, the output component 214 can export the output document 216.

The data manipulation system 108 supports live programming of data manipulation tasks using a sequence of steps (e.g., forming the structured data 206, performing a given operation, etc.). Thus, a user can refine each step (e.g., via the uniform user interface 212 provided by the interaction component 112) until satisfied with the performance of such step. For instance, if a particular step uses PBE technologies, then additional positive and/or negative examples (e.g., the example(s) 202) can be received via the interaction component 112 to refine such step. Moreover, if a particular step uses PBNL technologies, then the natural language input(s) 204 can be refined via the interaction component 112 to refine that particular step.

By way of example, the extraction component 114 can be configured to synthesize an updated first program for parsing the data of the input document 102 based on a refined first input. The refined first input can be received by the interaction component 112 subsequent to execution of the first program on the input document 102. The refined first input can cause refinement of the structured data 206. The extraction component 114 can be configured to execute the updated first program on the input document 102 to form updated structured data. Thus, the operation component 116 can synthesize the second program for performing the operation on the updated structured data and execute the second program on the updated structured data.

In accordance with another example, the operation component 116 can be configured to synthesize an updated second program for performing the operation on the structured data based on a refined second input. The refined second input can be received by the interaction component 112 subsequent to execution of the second program. The refined second input can cause refinement of the result. The operation component 116 can further be configured to execute the updated second program on the structured data 206 to generate an updated result of the operation. The updated result of the operation can be output by the data manipulation system 108.

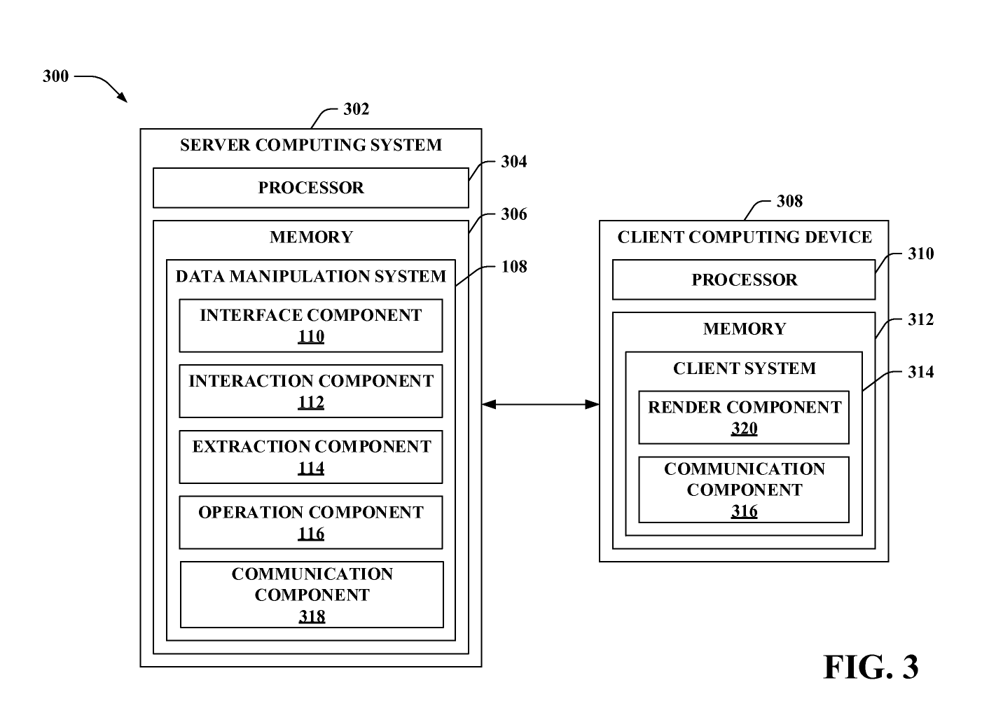

According to an example, the data manipulation system 108 (e.g., the interaction component 112) can receive the first input and the second input (e.g., the example(s) 202 and/or the natural language input(s) 204) from a user of a computing system that includes the data manipulation system 108 (e.g., a user of the computing system 100 of FIG. 1). By way of illustration, the first and second inputs can be received from the user via input device(s) of the computing system 100 of FIG. 1. In accordance with another example, the data manipulation system 108 can receive the first input and the second input (e.g., the example(s) 202 and/or the natural language input(s) 204) from a client computing device, where the client computing device can receive the first and second inputs from the user, as described in greater detail in connection with FIG. 3.

Turning to FIG. 3, illustrated is a system 300 that employs server-side control of programming for data manipulation tasks executed on an input document (e.g., the input document 102). The system 300 includes a server computing system 302 (e.g., the computing system 100 of FIG. 1). The server computing system 302 includes one or more processors 304 and memory 306. The memory 306 includes the data manipulation system 108. As described herein, the data manipulation system 108 can include the interface component 110, the interaction component 112, the extraction component 114, and the operation component 116.

The system 300 further includes a client computing device 308. The client computing device 308 can include at least one processor 310 and memory 312. The memory 312 can include a client system 314 that interacts with the data manipulation system 108. Examples of the client computing device 308 include a desktop computing device, a mobile computing device (e.g., a mobile telephone such as a smartphone, a laptop computing device, a netbook computing device, a tablet computing device, a wearable computing device, a handheld computing device, a portable gaming device, a personal digital assistant, an automotive computer, etc.), a gaming console, a set-top box, a television, an embedded computing device, or the like.

The client computing device 308 can receive the first input and the second input (e.g., the example(s) and/or the natural language input(s)) from a user of the client computing device 308. The inputs can be received via input device(s) of the client computing device 308, for instance (e.g., the client computing device 308 can include or be coupled with the input device(s)).

The client system 314 can include a communication component 316 configured to transmit the first input and the second input to the server computing system 302. The communication component 316 can also transmit an input document or an indicator that specifies an input document to the server computing system 302. The data manipulation system 108 can further include a communication component 318 configured to receive the first input and the second input from the client computing device 308. Moreover, the communication component 318 can receive the input document or the indicator that specifies the input document. The communication component 318 of the data manipulation system 108 can also be configured to transmit the result of the operation to the client computing device 308, and the communication component 316 of the client system 314 can be configured to receive the result of the operation.

Further, the communication component 318 of the data manipulation system 108 can be configured to transmit data indicative of the uniform user interface generated by the interaction component 112 to the client computing device 308, and the communication component 316 of the client system 314 can receive such data. The client system 314 can include a render component 320 that can render the uniform user interface based on the data indicative of the uniform user interface received from the data manipulation system 108. For instance, the uniform user interface can be rendered by the render component 320 on a display device of the client computing device 308 (e.g., the client computing device 308 can include or be coupled with a display device).

Two exemplary scenarios are set forth below for illustration purposes. It is to be appreciated that these exemplary scenarios are presented to illustrate operation of the data manipulation system 108. However, it is contemplated that other scenarios are intended to fall within the scope of the hereto appended claims.

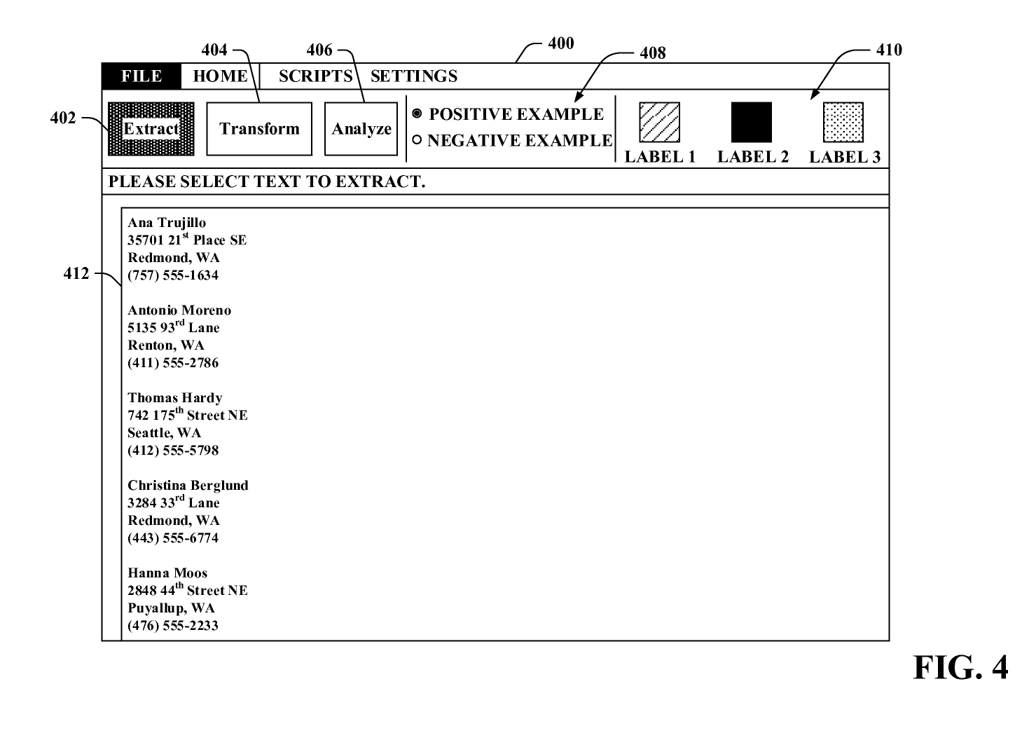

FIGS. 4-8 illustrate a uniform user interface (e.g., the uniform user interface 212) generated by the interaction component 112 that can be rendered upon a display device of a computing device (e.g., the computing system 100, the client computing device 308) during operation of the data manipulation system 108 in accordance with a first exemplary scenario. In the first exemplary scenario, a text file (e.g., log file) can be imported to the data manipulation system 108 via the interface component 110.

Turning to FIG. 4, illustrated is a uniform user interface 400. The uniform user interface 400 includes data manipulation task tabs, namely, an extract tab 402, a transform tab 404, and an analyze tab 406. As depicted in FIG. 4, the extract tab 402 is selected, which causes an example type selection region 408 and a label selection region 410 to be displayed as part of the uniform user interface 400. In the example type selection region 408, a positive example button or a negative example button can be selected. When the positive example button is selected, one or more positive examples can be inputted via the uniform user interface 400. Moreover, when the negative example button is selected, one or more negative examples can be inputted via the uniform user interface 400. Moreover, in the label selection region 410, a plurality of labels can be selected; each of the labels can have a corresponding highlight color. While three labels are shown, it is contemplated that substantially any number of labels can be included as part of the uniform user interface 400. Moreover, the uniform user interface 400 includes a region 412 that includes data of an input document (e.g., the input document 102). As noted above, the uniform user interface 400 is uniform for a variety of input document formats.

As illustrated in FIG. 4, the input document is a log file. Thus, the region 412 includes data from the log file. The log file in this exemplary scenario include a collection of person records, where each record includes a name, address, and phone number.

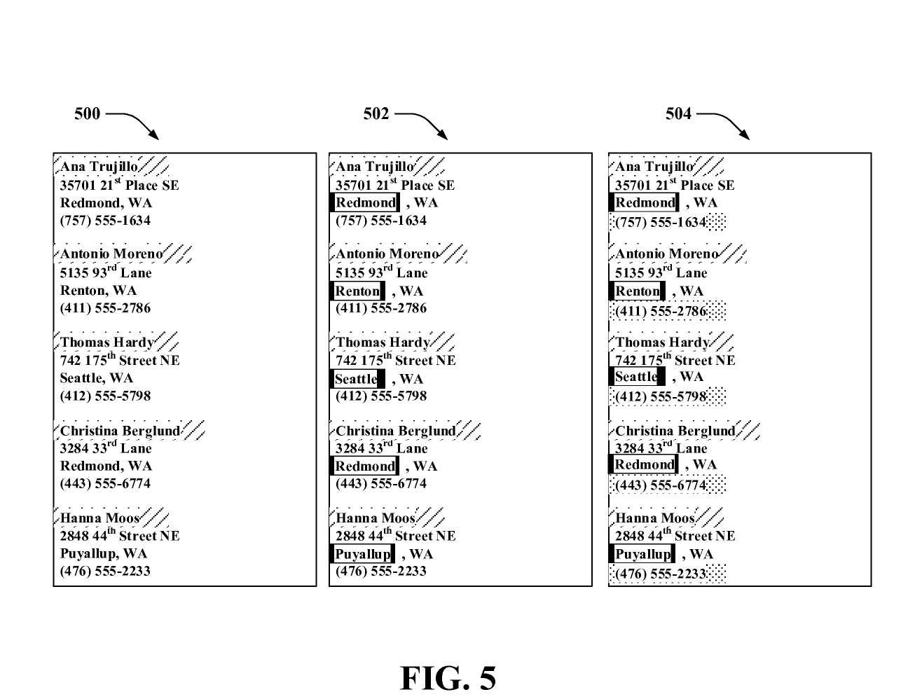

As set forth below (and shown in FIGS. 5-8), the data manipulation system 108 can be used to perform the following tasks as part of the first exemplary scenario.

Task A—The name of each person in the log file can be extracted, along with the city where the person lives and their phone number. The extracted data, for instance, can be output in a spreadsheet table (e.g., the output document 216 produced by the output component 214).

Task B—The log file can be edited to transform the name from “First-Name Last-Name” format to “Last-Name, First-Name” format.

Task C—The number of people who live in Redmond can be counted.

The following describes an exemplary implementation of task A of the first exemplary scenario in greater detail. Starting from the view of the data from the log file in the region 412 as depicted in FIG. 4, a user can first provide two examples (e.g., positive examples) of names by highlighting the two names in a first color (e.g., Label 1 corresponding to the first color can be chosen in the label selection region 410 of the uniform user interface 400 of FIG. 4). For instance, “Ana Trujillo” and “Antonio Moreno” can be highlighted in the first color. Responsive to the positive examples highlighted in the first color via the uniform user interface 400, the extraction component 114 can automatically infer a pattern to extract other similar strings from the log file. Thus, the extraction component 114 can synthesize and execute a program (or programs) for parsing the data of the log file based on the examples highlighted in the first color.

FIG. 5 illustrates three views of the data from the log file in the region 412 during task A, namely, a view 500, a view 502, and a view 504. As shown in the view 500, the similar strings from the log file extracted based upon the automatically inferred pattern can be highlighted in the first color. Thus, as depicted in the view 500, “Thomas Hardy”, “Christina Berglund”, and so forth are also highlighted in the first color. It is contemplated that additional positive or negative example(s) can be provided if the user is unsatisfied with the similar strings as highlighted, which can cause updating of the automatically inferred pattern.

Next, the user can provide one example (e.g., positive example) of a city by highlighting a city in a second color (e.g., Label 2 corresponding to the second color can be chosen in the label selection region 410 of the uniform user interface 400 of FIG. 4). For instance, “Redmond” in the record for “Ana Trujillo” can be highlighted in the second color. Responsive to the positive example highlighted in the second color (e.g., via the uniform user interface 400), the extraction component 114 can automatically infer a pattern to extract other similar strings from the log file and highlight the similar strings, as shown in the view 502. Similar to above, additional example(s) can be provided for refinement if the user is unsatisfied with the highlighting.

Thereafter, the user can provide one example (e.g., a positive example) of a phone number by highlighting a phone number in a third color (e.g., Label 3 corresponding to the third color can be chosen in the label selection region 410 of the uniform user interface 400 of FIG. 4). For instance, the phone number in the record for “Ana Trujillo” can be highlighted in the third color. Similar to above, responsive to the positive example highlighted in the third color (e.g., via the uniform user interface 400), the extraction component 114 can automatically infer a pattern to extract other similar strings from the log file and highlight the similar strings, as shown in the view 504. Moreover, like above, additional example(s) can be provided for refinement if the user is unsatisfied with the highlighting.

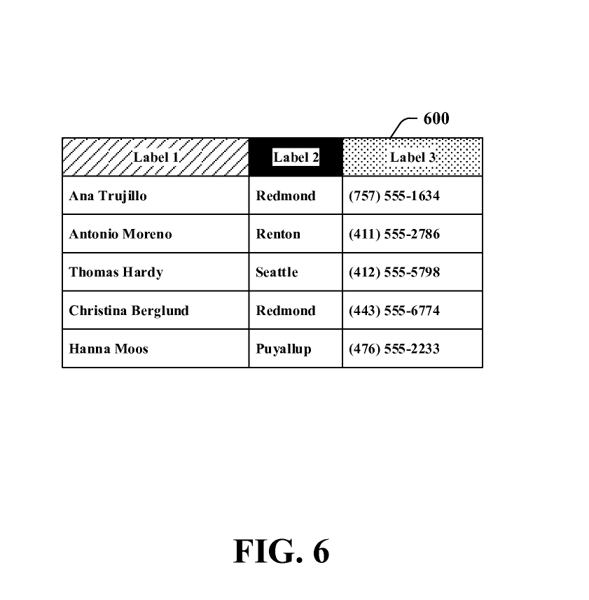

The highlighted data (e.g., parsed data, structured data) further can be extracted in a table 600 as shown in FIG. 6. As depicted in the table 600, corresponding fields respectively highlighted in the first, second, and third colors that constitute the same record can be matched together. The table 600, for instance, can be generated by the output component 214; however, the claimed subject matter is not so limited.

According to another exemplary implementation of task A of the first exemplary scenario, a nested extraction structure can be defined. From the view of the data of the log file in the region 412 as shown in FIG. 4, a user can provide two examples (e.g., positive examples) of records by highlighting lines included in the two records in a first color (e.g., Label 1 corresponding to the first color can be chosen in the label selection region 410 of the uniform user interface 400 of FIG. 4). For instance, the four lines of the record corresponding to “Ana Trujillo” (e.g., “Ana Trujillo”, “35701 21^{st} Place SE”, “Redmond, Wash.” and “(757) 555-1634”) and the four line of the record corresponding to “Antonio Moreno” (e.g., “Antonio Moreno”, “5135 93^{rd} Lane”, “Renton, WA” and “(411) 555-2786) can be highlighted in the first color. Responsive to the positive examples highlighted in the first color via the uniform user interface 400, the extraction component 114 can automatically infer a pattern to extract other similar records from the log file. Accordingly, the extraction component 114 can synthesize and execute a program (or programs) for parsing the data of the log file based on the examples highlighted in the first color. After execution, the records of the log file as extracted can be highlighted in the first color.

Following this exemplary implementation of task A, the user can provide one example (e.g., positive example) of a name in a record in a second color (e.g., Label 2 corresponding to the second color can be chosen in the label selection region 410 of the uniform user interface 400 of FIG. 4). For instance, “Ana Trujillo” can be highlighted in the second color; responsive thereto, the extraction component 114 can automatically infer a pattern to extract other similar strings from the log file and highlight other similar strings from the other records in the log file. An example of a city in a record (e.g., “Redmond” in the record for “Ana Trujillo”) and a phone number (e.g., (757) 555-1634″) can similarly be highlighted in a third color and a fourth color respectively, and similarly used to highlight cities and phone numbers in other records.

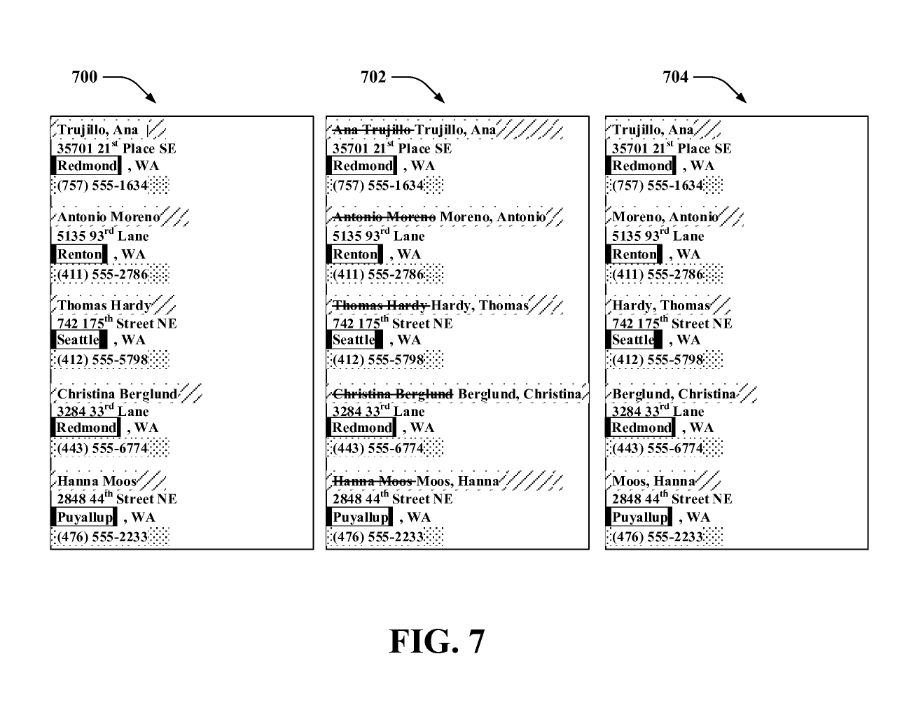

Below, task B of the first exemplary scenario is described in greater detail. Repetitive edits to the parsed log file to transform names from “First-Name Last-Name” format to “Last-Name, First-Name” format can be performed by selecting the transform tab 404 in the uniform user interface 400 of FIG. 4. FIG. 7 illustrates three views of the data from the log file in the region 412 during task B, namely, a view 700, a view 702, and a view 704.

An example of a desired string transformation can initially be input via the uniform user interface 400. As shown in the view 700, “Ana Trujillo” can be changed to “Trujillo, Ana” via the uniform user interface 400.

Next, upon receiving input to run the transformation (e.g., via a run button (not shown) of the uniform user interface 400), a preview of how the log file will be transformed by the transformation component 208 can be displayed as depicted in the view 702. More particularly, the view 702 shows changes made to the structured data of the log file, with strikethroughs representing deletions.

Thereafter, upon receiving input to confirm the transformation (e.g., via a confirm button (not shown) of the uniform user interface 400), the transformation can be performed by the transformation component 208. The view 704 illustrates the data of the log file subsequent to performance of the transformation. The transformation component 208 can cause the input document 102 to be modified via the interface component 110 responsive to receipt of the confirmation input; however, the claimed subject matter is not so limited (e.g., the input document 102 may be unable to be modified by the data manipulation system 108, the data manipulation system 108 can be inhibited from modifying the input document 102 while the data model of the input document 102 for the data manipulation system 108 is modified, etc.).

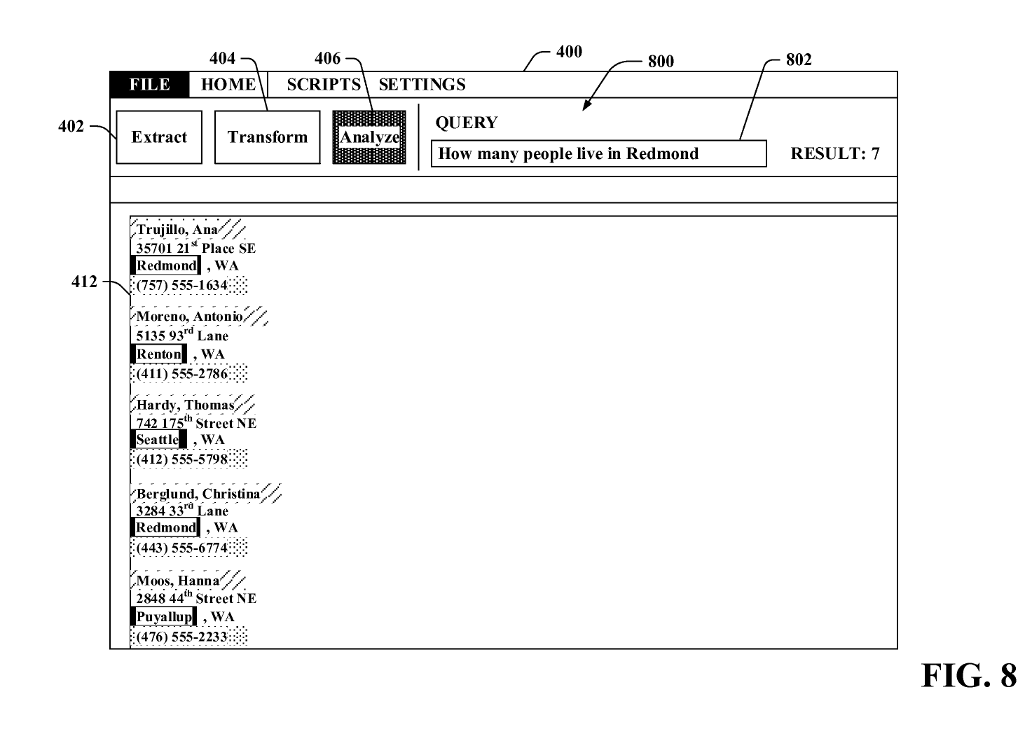

Reference is now made to FIG. 8 in connection with task C of the first exemplary scenario. FIG. 8 again depicts the uniform user interface 400. As illustrated in FIG. 8, the analyze tab 406 is selected, which causes a query region 800 to be displayed as part of the uniform user interface 400. A natural language query command can be entered into a textbox 802 of the uniform user interface 400 (e.g., the natural language query command “How many people live in Redmond” is received via the uniform user interface 400 in the example of FIG. 8). The natural language query command can be interpreted and executed over the parsed log file by the query component 210 to return a result. As shown in FIG. 8, the result of “7” is displayed via the uniform user interface 400.

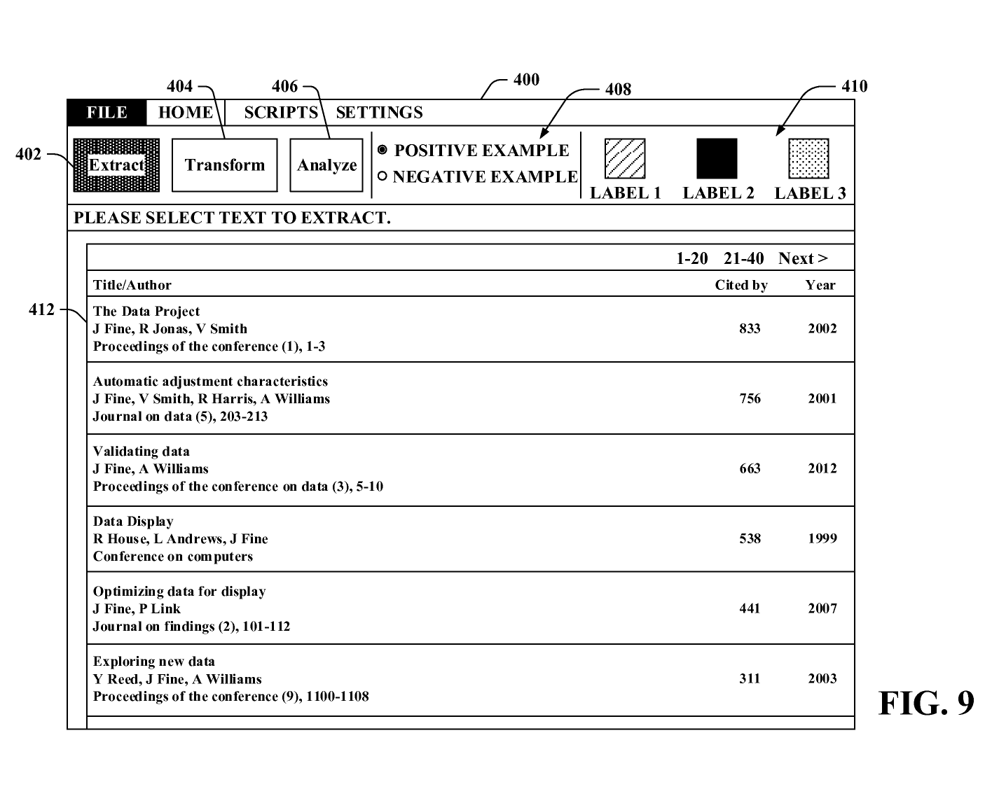

FIGS. 9-12 illustrate a uniform user interface that can be generated by the interaction component 112 and rendered upon a display device of a computing device (e.g., the computing system 100, the client computing device 308) during operation during operation of the data manipulation system 108 in accordance with a second exemplary scenario. In the second exemplary scenario, a webpage can be imported to the data manipulation system 108 via the interface component 110.

Reference is now made to FIG. 9. As noted above, the uniform user interface 400 is uniform for a variety of input document formats; thus, the uniform user interface 400 is substantially similar in FIG. 9 as compared to FIG. 4. As shown in FIG. 9, the extract tab 402 is selected. Moreover, in the example shown in FIG. 9, the input document 102 is a webpage. Thus, the region 412 includes data from the webpage.

For the second exemplary scenario, the webpage includes a collection of publication records for an author named “Joe Fine.” The publication records each include a title, author name(s), as well as other details. As described in greater detail below, the data manipulation system 108 can be used to perform the following tasks as part of the second exemplary scenario.

Task A—The title and first author of each publication can be extracted.

Task B—The number of publications where “Joe Fine” is the first author can be counted.

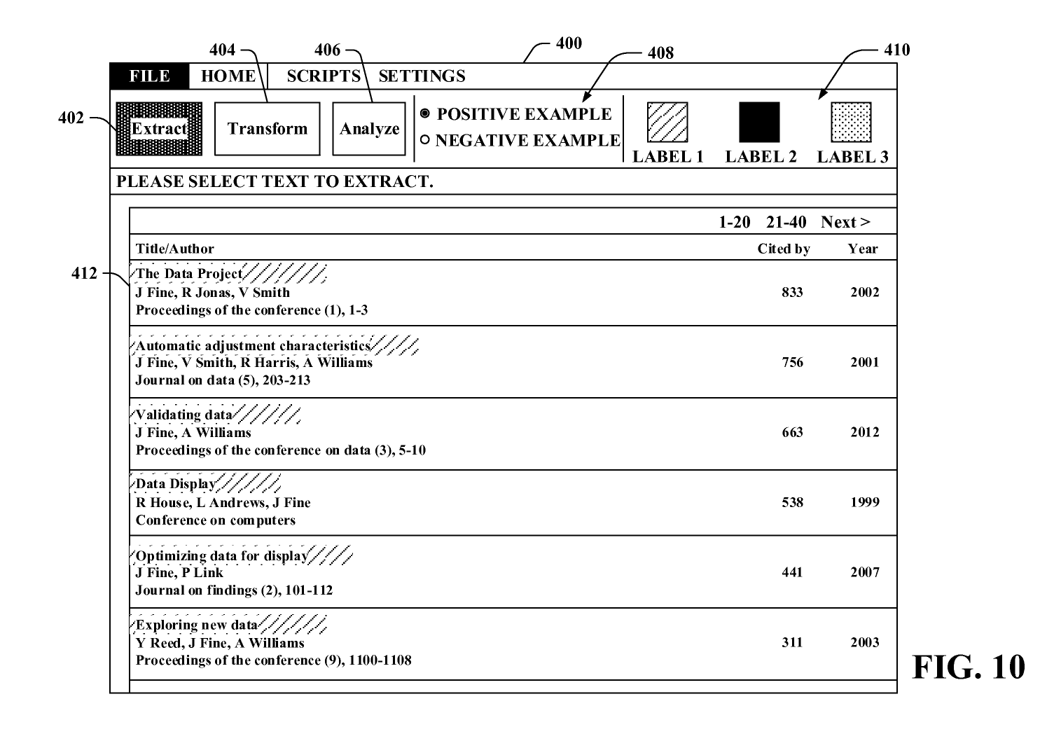

The following describes task A of the second exemplary scenario in greater detail. Starting from the view of the data from the webpage in the region 412 as depicted in FIG. 9, a user can first provide an example (e.g., positive example) of a title by highlighting a title in a first color (e.g., Label 1 corresponding to the first color can be chosen in the label selection region 410 of the uniform user interface 400 of FIG. 9). For instance, “The Data Project” can be highlighted in the first color. Responsive to the positive example highlighted in the first color via the uniform user interface 400, the extraction component 114 can automatically infer a pattern to extract other similar strings from the webpage. FIG. 10 shows the similar strings from the webpage extracted based upon the automatically inferred pattern highlighted in the first color in the region 412. Additional positive and/or negative example(s) can be provided for refinement if the user is unsatisfied with the highlighting.

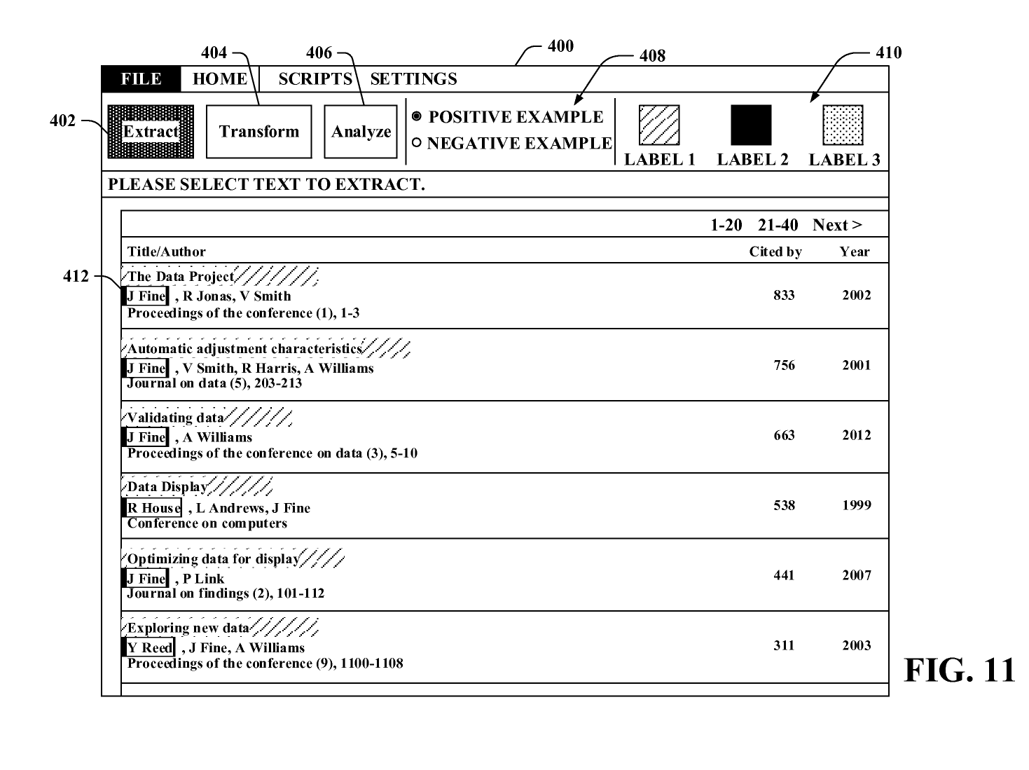

Next, the user can provide one example (e.g., positive example) of a first author by highlighting a first author in a second color (e.g., Label 2 corresponding to the second color can be chosen in the label selection region 410 of the uniform user interface 400 of FIG. 10). By way of illustration, “J Fine” in the publication record for “The Data Project” can be highlighted in the second color. Responsive to the positive example highlighted in the second color via the uniform user interface 400, the extraction component 114 can automatically infer a pattern to extract other similar strings from the webpage. FIG. 11 depicts the similar strings from the webpage extracted based upon the automatically inferred pattern highlighted in the second color in the region 412. Similar to above, additional example(s) can be provided for refinement if the user is unsatisfied with the highlighting.

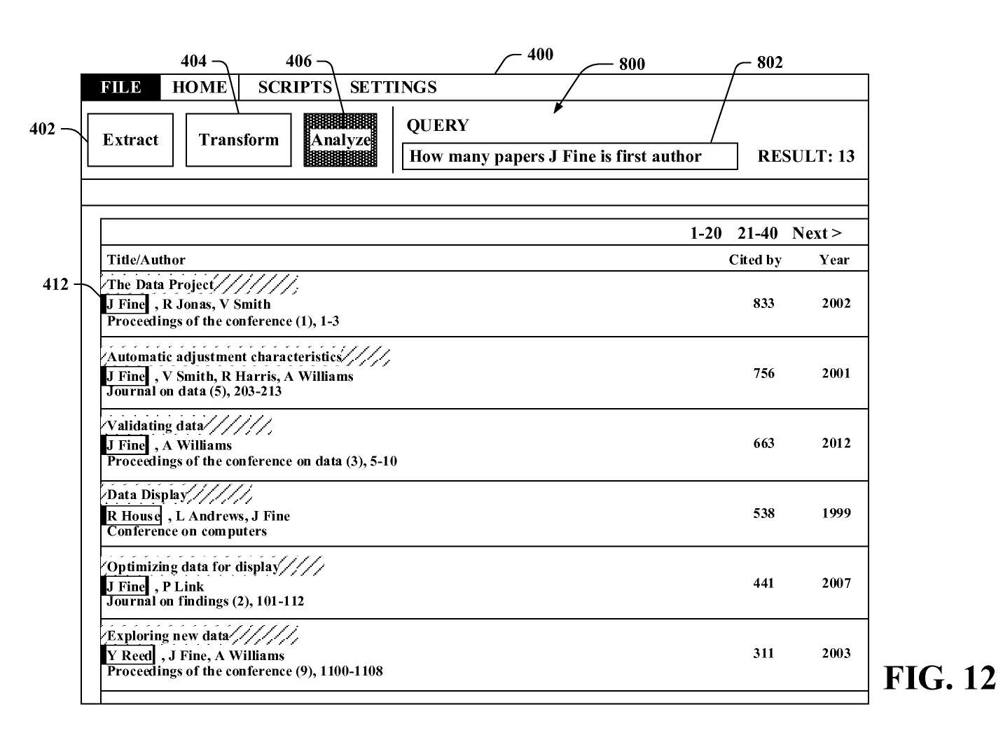

Below, task B of the second exemplary scenario is described in greater detail. Reference is now made to FIG. 12, which again shows the uniform user interface 400. As illustrated in FIG. 12, the analyze tab 406 is selected, which causes the query region 800 to be displayed as part of the uniform user interface 400. A natural language query command can be entered into a textbox 802 of the uniform user interface 400 (e.g., the natural language query command “How many papers J Fine is first author” is received via the uniform user interface 400 in the example of FIG. 12). The natural language query command can be interpreted and executed over the parsed webpage (e.g., the structured data) by the query component 210 to return a result. As shown in FIG. 12, the result of “13” is displayed via the uniform user interface 400.

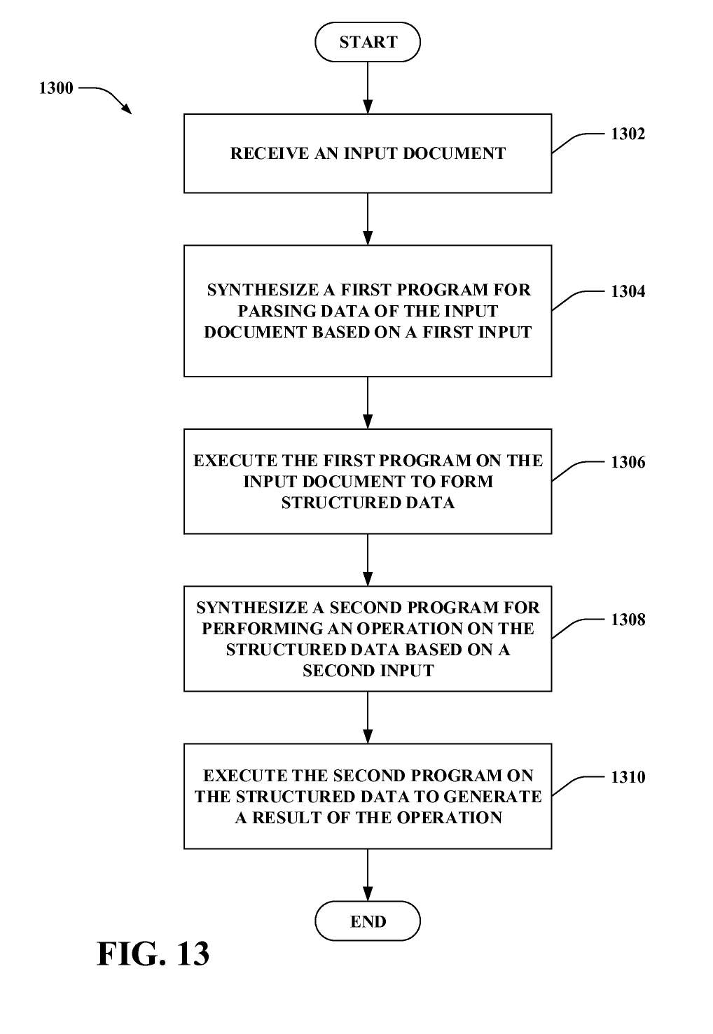

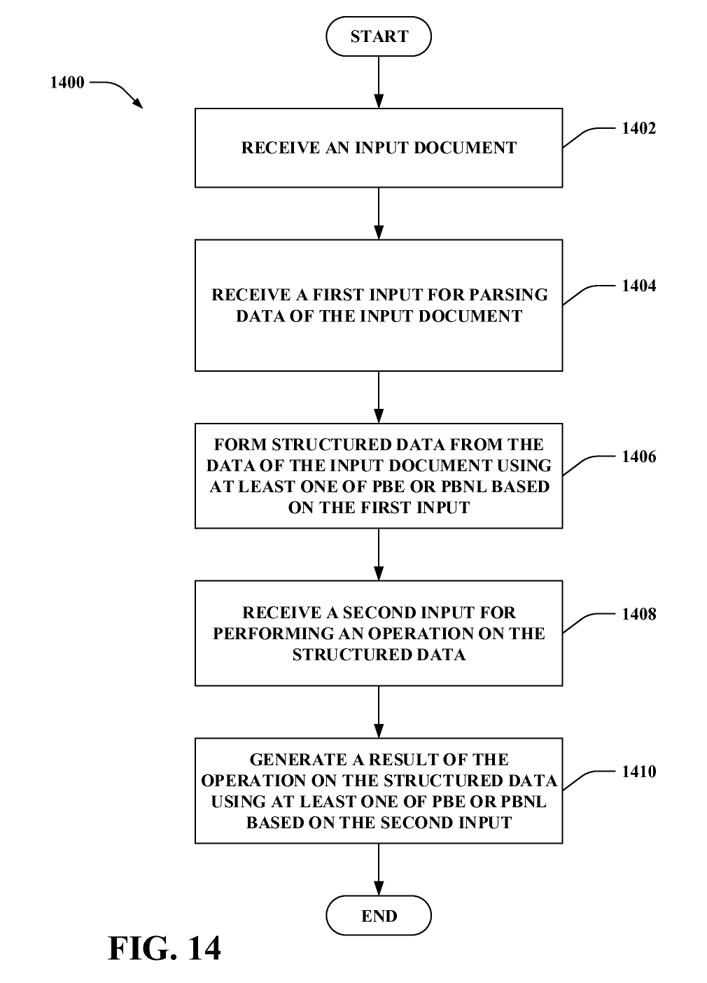

FIGS. 13-14 illustrate exemplary methodologies relating to controlling programming for data manipulation executed on an input document based on example(s) and/or natural language input(s). While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

FIG. 13 illustrates a methodology 1300 of controlling programming for data manipulation executed on data of an input document. At 1302, an input document can be received. The input document can be a semi-structured document or an unstructured document. At 1304, a first program for parsing data of the input document can be synthesized based on a first input. At 1306, the first program can be executed on the input document to form structured data. At 1308, a second program for performing an operation on the structured data can be synthesized based on data of a second input. At 1310, the second program can be executed on the structured data to generate a result of the operation. Moreover, the result of the operation can be outputted.

With reference to FIG. 14, illustrated is another methodology 1400 of controlling programming for data manipulation executed on data of an input document. At 1402, an input document can be received. At 1404, a first input for parsing data of the input document can be received. At 1406, structured data can be formed from the data of the input document using at least one of programming by example (PBE) or programming by natural language (PBNL) based on the first input. At 1408, a second input for performing an operation on the structured data can be received. At 1410, a result of the operation on the structured data can be generated using at least one of PBE or PBNL based on the second input.

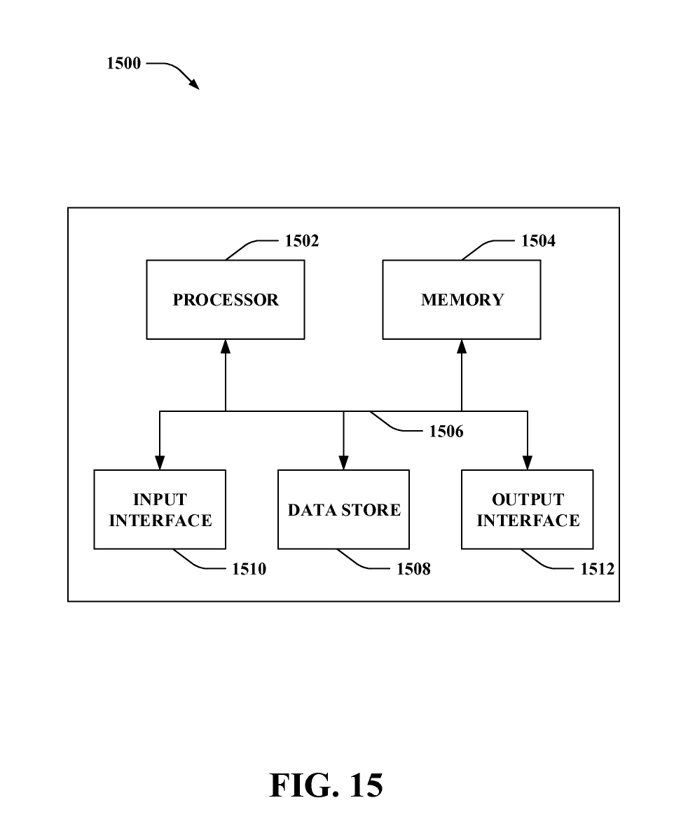

Referring now to FIG. 15, a high-level illustration of an exemplary computing device 1500 that can be used in accordance with the systems and methodologies disclosed herein is illustrated. For instance, the computing device 1500 may be or include the computing system 100 of FIG. 1. According to another example, the computing system 100 of FIG. 1 can include the computing device 1500. Pursuant to another example, the server computing system 302 of FIG. 3 can be or include the computing device 1500. By way of yet another example, the computing device 1500 may be or include the client computing device 308 of FIG. 3. The computing device 1500 includes at least one processor 1502 that executes instructions that are stored in a memory 1504. The instructions may be, for instance, instructions for implementing functionality described as being carried out by one or more components discussed above or instructions for implementing one or more of the methods described above. The processor 1502 may access the memory 1504 by way of a system bus 1506. In addition to storing executable instructions, the memory 1504 may also store input document(s), example(s), natural language input(s), synthesized program(s), data pertaining to the uniform user interface, and so forth.

The computing device 1500 additionally includes a data store 1508 that is accessible by the processor 1502 by way of the system bus 1506. The data store 1508 may include executable instructions, input document(s), example(s), natural language input(s), synthesized program(s), data pertaining to the uniform user interface, etc. The computing device 1500 also includes an input interface 1510 that allows external devices to communicate with the computing device 1500. For instance, the input interface 1510 may be used to receive instructions from an external computer device, from a user, etc. The computing device 1500 also includes an output interface 1512 that interfaces the computing device 1500 with one or more external devices. For example, the computing device 1500 may display text, images, etc. by way of the output interface 1512.

It is contemplated that the external devices that communicate with the computing device 1500 via the input interface 1510 and the output interface 1512 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 1500 in a manner free from constraints imposed by input device(s) such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 1500 may be a distributed system. Thus, for instance, several devices may be in communication by way of a network connection and may collectively perform tasks described as being performed by the computing device 1500.

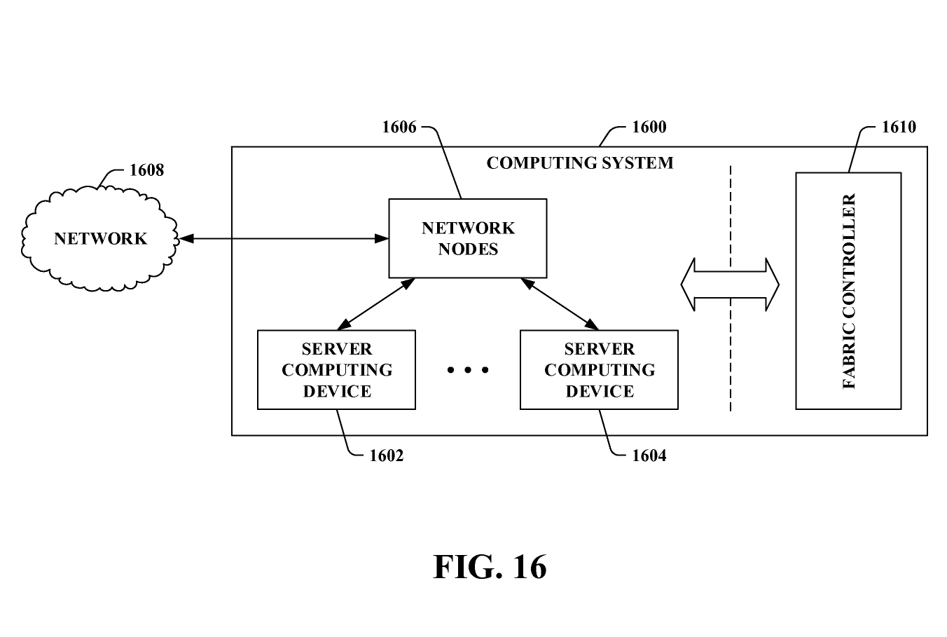

Turning to FIG. 16, a high-level illustration of an exemplary computing system 1600 that can be used in accordance with the systems and methodologies disclosed herein is illustrated. For instance, the computing system 1600 can be or include the computing system 100. Additionally or alternatively, the computing system 100 can be or include the computing system 1600. According to other examples, the computing system 1600 can be or include the server computing system 302, or the server computing system 302 can be or include the computing system 1600.

The computing system 1600 includes a plurality of server computing devices, namely, a server computing device 1602, . . . , and a server computing device 1604 (collectively referred to as server computing devices 1602-1604). The server computing device 1602 includes at least one processor and memory; the at least one processor executes instructions that are stored in the memory. The instructions may be, for instance, instructions for implementing functionality described as being carried out by one or more systems or components discussed above or instructions for implementing one or more of the methods described above. Similar to the server computing device 1602, at least a subset of the server computing devices 1602-1604 other than the server computing device 1602 each respectively include at least one processor and memory. Moreover, at least a subset of the server computing devices 1602-1604 include respective data stores.

Processor(s) of one or more of the server computing devices 1602-1604 can be or include the processor 104. Further, memory (or memories) of one or more of the server computing devices 1602-1604 can be or include the memory 106. According to another example, processor(s) of one or more of the server computing devices 1602-1604 can be or include the processor 304, and memory (or memories) of one or more of the server computing devices 1602-1604 can be or include the memory 306.

The computing system 1600 further includes various network nodes 1606 that transport data between the server computing devices 1602-1604. Moreover, the network nodes 1602 transport data from the server computing devices 1602-1604 to external nodes (e.g., external to the computing system 1600) by way of a network 1608. The network nodes 1602 also transport data to the server computing devices 1602-1604 from the external nodes by way of the network 1608. The network 1608, for example, can be the Internet, a cellular network, or the like. The network nodes 1606 include switches, routers, load balancers, and so forth.

A fabric controller 1610 of the computing system 1600 manages hardware resources of the server computing devices 1602-1604 (e.g., processors, memories, data stores, etc. of the server computing devices 1602-1604). The fabric controller 1610 further manages the network nodes 1606. Moreover, the fabric controller 1610 manages creation, provisioning, de-provisioning, and supervising of virtual machines instantiated upon the server computing devices 1602-1604.

Various examples are now set forth.

### Example 1

A computing system, comprising: at least one processor; and memory comprising a data manipulation system, the data manipulation system being executable by the at least one processor, the data manipulation system comprising: an interface component configured to receive an input document, the input document being at least one of a semi-structured document or an unstructured document; an extraction component configured to: synthesize a first program for parsing data of the input document, the first program synthesized based on a first input; and execute the first program on the input document to form structured data; and an operation component configured to: synthesize a second program for performing an operation on the structured data, the second program synthesized based on a second input; and execute the second program on the structured data to generate a result of the operation, the result of the operation being output by the data manipulation system.

### Example 2

The computing system according to Example 1, the first input comprises at least one of a first example or a first natural language input, and the second input comprises at least one of a second example or a second natural language input.

### Example 3

The computing system according to any of Examples 1-2, the extraction component further configured to synthesize the first program using at least one of programming by example (PBE) or programming by natural language (PBNL), and the operation component further configured to synthesize the second program using at least one of PBE or PBNL.

### Example 4

The computing system according to any of Examples 1-3, the second program being a transformation program for transforming text strings having a selection criterion, the structured data comprising the text strings, the operation component further comprising a transformation component configured to: synthesize the transformation program based on the second input, the second input providing a modified text string corresponding to a text string in the structured data, the modified text string indicative of a transformation performed on the text string, the transformation program configured to transform the text strings having the selection criterion in the structured data to corresponding modified text strings; evaluate the structured data to identify the text strings having the selection criterion; and transform the text strings having the selection criterion to the corresponding modified text strings using the transformation program.

### Example 5

The computing system according to any of Examples 1-4, the second program being a query program, the operation component further comprising a query component configured to: synthesize the query program based on the second input and the structured data, the second input comprising a natural language query; and generate the result using the query program, the result being responsive to the natural language query.

### Example 6

The computing system according to any of Examples 1-5, the extraction component further configured to: synthesize an updated first program for parsing the data of the input document based on a refined first input subsequent to execution of the first program on the input document, the refined first input causing refinement of the structured data; and execute the updated first program on the input document to form updated structured data; wherein the operation component synthesizes the second program for performing the operation on the updated structured data and executes the second program on the updated structured data.

### Example 7

The computing system according to any of Examples 1-6, the operation component further configured to: synthesize an updated second program for performing the operation on the structured data based on a refined second input, the refined second input causing refinement of the result; and execute the updated second program on the structured data to generate an updated result of the operation, the updated result of the operation being output by the data manipulation system.

### Example 8

The computing system according to any of Examples 1-7, the data manipulation system further comprising an interaction component configured to: responsive to receipt of the first input, incorporate a graphical representation of the first input as part of a uniform user interface, the uniform user interface comprising a region that includes the data of the input document; responsive to execution of the first program, incorporate the structured data as part of the uniform user interface; responsive to receipt of the second input, incorporate a graphical representation of the second input as part of the uniform user interface; and responsive to execution of the second program, incorporate the result of the operation as part of the uniform user interface.

### Example 9

The computing system according to Example 8, the graphical representation of the first input comprising a highlighted region over a portion of the data of the input document, the first program synthesized based at least on the portion of the data of the input document included in the highlighted region.

### Example 10

The computing system according to any of Examples 8-9, the interaction component further configured to receive the first input and the second input from a user of the computing system.

### Example 11

The computing system according to any of Examples 1-10, the input document being one of a text file, a log file, a word processor document, a semi-structured spreadsheet, a webpage, or a fixed-layout document.

### Example 12

The computing system according to any of Examples 1-11, the data manipulation system further comprising a communication component configured to: receive the first input and the second input from a client computing device; and transmit the result of the operation to the client computing device.

### Example 13

The computing system according to any of Examples 1-12, the extraction component configured to form the structured data having one of a tabular structure or a tree-shaped structure.

### Example 14

The computing system according to any of Examples 1-13, the input document comprising at least one of a nested structure, a non-uniform structure, nested records, or sub-headers.

### Example 15

A method of controlling programming for data manipulation executed on data of an input document, comprising: receiving the input document, the input document being at least one of a semi-structured document or an unstructured document; receiving a first input for parsing the data of the input document; forming structured data from the data of the input document using at least one of programming by example (PBE) or programming by natural language (PBNL) based on the first input; receiving a second input for performing an operation on the structured data; and generating a result of the operation on the structured data using at least one of PBE or PBNL based on the second input.

### Example 16

The method according to Example 15, the operation being transformation of text strings in the structured data having a selection criterion.

### Example 17

The method according to any of Examples 15-16, the operation being execution of a natural language query over the structured data.

### Example 18

The method according to any of Examples 15-17, further comprising: responsive to receipt of the first input, incorporating a graphical representation of the first input as part of a uniform user interface, the uniform user interface comprising a region that includes the data of the input document; responsive to formation of the structured data, incorporating the structured data in the region of the uniform user interface, the structured data being incorporated by including highlighted regions over portions of the data of the input document; responsive to receipt of the second input, incorporating a graphical representation of the second input as part of the uniform user interface; and incorporating the result of the operation as part of the uniform user interface.

### Example 19

A computing system, comprising: at least one processor; and memory comprising a data manipulation system, the data manipulation system being executable by the at least one processor, the data manipulation system comprising: an interface component configured to receive an input document, the input document being one of a text file, a log file, a word processor document, a semi-structured spreadsheet, a webpage, or a fixed-layout document; an extraction component configured to form structured data from data of the input document using at least one of programming by example (PBE) or programming by natural language (PBNL); and an operation component configured to generate a result of an operation on the structured data using at least one of PBE or PBNL, the result of the operation being output by the data manipulation system.

### Example 20

The computing system according to Example 19, the data manipulation system further comprising an interaction component configured to: incorporate the structured data in a region of a uniform user interface, the region includes the data of the input document, the structured data being incorporated by including highlighted regions over portions of the data of the input document; and incorporate the result of the operation as part of the uniform user interface.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something.”

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A computing system, comprising:
at least one processor; and
memory comprising a data manipulation system, the data manipulation system being executable by the at least one processor, the data manipulation system comprising:
an interface component configured to receive an input document, the input document being at least one of a semi-structured document or an unstructured document;
an extraction component configured to:
synthesize a first program for parsing data of the input document, the first program synthesized based on a first input; and
execute the first program on the input document to form structured data; and
an operation component configured to:
synthesize a second program for performing an operation on the structured data, the second program synthesized based on a second input; and
execute the second program on the structured data to generate a result of the operation, the result of the operation being output by the data manipulation system.

2. The computing system of claim 1, the first input comprises at least one of a first example or a first natural language input, and the second input comprises at least one of a second example or a second natural language input.

3. The computing system of claim 1, the extraction component further configured to synthesize the first program using at least one of programming by example (PBE) or programming by natural language (PBNL), and the operation component further configured to synthesize the second program using at least one of PBE or PBNL.

4. The computing system of claim 1, the second program being a transformation program for transforming text strings having a selection criterion, the structured data comprising the text strings, the operation component further comprising a transformation component configured to:
synthesize the transformation program based on the second input, the second input providing a modified text string corresponding to a text string in the structured data, the modified text string indicative of a transformation performed on the text string, the transformation program configured to transform the text strings having the selection criterion in the structured data to corresponding modified text strings;
evaluate the structured data to identify the text strings having the selection criterion; and
transform the text strings having the selection criterion to the corresponding modified text strings using the transformation program.

5. The computing system of claim 1, the second program being a query program, the operation component further comprising a query component configured to:
synthesize the query program based on the second input and the structured data, the second input comprising a natural language query; and
generate the result using the query program, the result being responsive to the natural language query.

6. The computing system of claim 1, the extraction component further configured to:
synthesize an updated first program for parsing the data of the input document based on a refined first input subsequent to execution of the first program on the input document, the refined first input causing refinement of the structured data; and
execute the updated first program on the input document to form updated structured data;
wherein the operation component synthesizes the second program for performing the operation on the updated structured data and executes the second program on the updated structured data.

7. The computing system of claim 1, the operation component further configured to:
synthesize an updated second program for performing the operation on the structured data based on a refined second input, the refined second input causing refinement of the result; and
execute the updated second program on the structured data to generate an updated result of the operation, the updated result of the operation being output by the data manipulation system.

8. The computing system of claim 1, the data manipulation system further comprising an interaction component configured to:
responsive to receipt of the first input, incorporate a graphical representation of the first input as part of a uniform user interface, the uniform user interface comprising a region that includes the data of the input document;
responsive to execution of the first program, incorporate the structured data as part of the uniform user interface;
responsive to receipt of the second input, incorporate a graphical representation of the second input as part of the uniform user interface; and
responsive to execution of the second program, incorporate the result of the operation as part of the uniform user interface.

9. The computing system of claim 8, the graphical representation of the first input comprising a highlighted region over a portion of the data of the input document, the first program synthesized based at least on the portion of the data of the input document included in the highlighted region.

10. The computing system of claim 8, the interaction component further configured to receive the first input and the second input from a user of the computing system.

11. The computing system of claim 1, the input document being one of a text file, a log file, a word processor document, a semi-structured spreadsheet, a webpage, or a fixed-layout document.

12. The computing system of claim 1, the data manipulation system further comprising a communication component configured to:
receive the first input and the second input from a client computing device; and
transmit the result of the operation to the client computing device.

13. The computing system of claim 1, the extraction component configured to form the structured data having one of a tabular structure or a tree-shaped structure.

14. The computing system of claim 1, the input document comprising at least one of a nested structure, a non-uniform structure, nested records, or sub-headers.

15. A method of controlling programming for data manipulation executed on data of an input document, comprising:
receiving the input document, the input document being at least one of a semi-structured document or an unstructured document;
receiving a first input for parsing the data of the input document;
forming structured data from the data of the input document using at least one of programming by example (PBE) or programming by natural language (PBNL) based on the first input;
receiving a second input for performing an operation on the structured data; and
generating a result of the operation on the structured data using at least one of PBE or PBNL based on the second input.

16. The method of claim 15, the operation being transformation of text strings in the structured data having a selection criterion.

17. The method of claim 15, the operation being execution of a natural language query over the structured data.

18. The method of claim 15, further comprising:
responsive to receipt of the first input, incorporating a graphical representation of the first input as part of a uniform user interface, the uniform user interface comprising a region that includes the data of the input document;
responsive to formation of the structured data, incorporating the structured data in the region of the uniform user interface, the structured data being incorporated by including highlighted regions over portions of the data of the input document;
responsive to receipt of the second input, incorporating a graphical representation of the second input as part of the uniform user interface; and
incorporating the result of the operation as part of the uniform user interface.

19. A computing system, comprising:
at least one processor; and
memory comprising a data manipulation system, the data manipulation system being executable by the at least one processor, the data manipulation system comprising:
an interface component configured to receive an input document, the input document being one of a text file, a log file, a word processor document, a semi-structured spreadsheet, a webpage, or a fixed-layout document;
an extraction component configured to form structured data from data of the input document using at least one of programming by example (PBE) or programming by natural language (PBNL); and
an operation component configured to generate a result of an operation on the structured data using at least one of PBE or PBNL, the result of the operation being output by the data manipulation system.

20. The computing system of claim 19, the data manipulation system further comprising an interaction component configured to:
incorporate the structured data in a region of a uniform user interface, the region includes the data of the input document, the structured data being incorporated by including highlighted regions over portions of the data of the input document; and
incorporate the result of the operation as part of the uniform user interface.
